(19) United States
(12) Patent Application Publication
(10) Pub. No.: US 2011/0081060 A1
(43) Pub. Date: Apr. 7, 2011

(54) Pathological-Diagnosis Support Device and Pathological-Diagnosis Support System

(75) Inventors: Mitsuyoshi Suwaki, Kanagawa (JP); Yoshihiro Kawano, Bethlehem, PA (US); Iwao Kanamori, Kanagawa (JP)

(73) Assignee: OLYMPUS CORPORATION, Tokyo (JP)

(21) Appl. No.: 12/897,836

(22) Filed: Oct. 5, 2010

(30) Foreign Application Priority Data
Oct. 6, 2009 (JP) 2009-234113

(51) Int. Cl. G06K 9/00; G06F 17/30

(52) U.S. Cl. 382/128; 707/769; 707/E17.014

(57) ABSTRACT

An object is to reduce the burden on pathologists and to improve the efficiency of pathologist's diagnoses. Provided is a pathological-diagnosis support device including a reference-information storing portion in which reference information referred to by a pathologist when making a pathological diagnosis is stored in association with the names of illnesses and the names of tissue sites; a diagnosis-request-information acquisition portion that acquires diagnosis request information including the name of the illness of a patient and the name of the tissue site; a diagnosis-content extracting portion that extracts the name of the illness and the name of the tissue site from the diagnosis request information acquired by the diagnosis-request-information acquisition portion; and a reference-information searching portion that searches the reference information stored in the reference-information storing portion using the name of the illness and the name of the tissue site extracted by the diagnosis-content extracting portion.

### BACKGROUND OF THE INVENTION

1. Field of the Invention

The present invention relates to pathological-diagnosis support devices and pathological-diagnosis support systems.

This application is based on Japanese Patent Application No. 2009-234113, the content of which is incorporated herein by reference.

2. Description of Related Art

There are known systems in the related art that integrate patient information stored in various information systems in a hospital (for example, see Japanese Unexamined Patent Application, Publication No. 2008-204461).

One method for diagnosing disease is pathological diagnosis, in which a diseased specimen collected from a patient's body is observed using a microscope for morphological diagnosis. The criteria for diagnosis are complex because samples created for pathological diagnosis look significantly different depending on the conditions, such as the type of illness, the tissue site, the collecting method, the position of at which the tissue is cut, the staining method, etc. Therefore, pathologists sometimes make diagnoses by referring to manuals, images of prior cases having conditions similar to those of the sample to be diagnosed, etc.

At this time, pathologists need to search reference information necessary for diagnosis, such as appropriate details in manuals and images having similar conditions existing in images of prior cases, one by one while viewing information related to the requested diagnosis. Furthermore, such reference information and patient's medical records are stored independently in a hospital. Therefore, it is inefficient for pathologists to find the necessary reference information.

### BRIEF SUMMARY OF THE INVENTION

An object of the present invention is to provide a pathological-diagnosis support device and a pathological-diagnosis support system that can reduce the burden on pathologists and can improve the efficiency of pathologist's diagnoses.

To achieve the above-described object, the present invention provides the following solutions.

A first aspect of the present invention is a pathological-diagnosis support device including a reference-information storing portion in which reference information referred to by a pathologist when making a pathological diagnosis is stored in association with, at least, the names of illnesses and the names of tissue sites indicated by the reference information; a diagnosis-request-information acquisition portion that acquires diagnosis request information including, at least, the name of the illness of a patient and the name of the tissue site; a diagnosis-content extracting portion that extracts, at least, the name of the illness and the name of the tissue site from the diagnosis request information acquired by the diagnosis-request-information acquisition portion; and a reference-information searching portion that searches the reference information stored in the reference-information storing portion using the name of the illness and the name of the tissue site extracted by the diagnosis-content extracting portion.

A second aspect of the present invention is a pathological-diagnosis support system including a reference-information storing server in which reference information referred to by a pathologist when making a pathological diagnosis is stored in association with, at least, the names of illnesses and the names of tissue sites indicated by the reference information; and a pathological-diagnosis support device that is connected to the reference-information storing server through a network. The pathological-diagnosis support device includes a diagnosis-request-information acquisition portion that acquires diagnosis request information including, at least, the name of the illness of a patient and the name of the tissue site; a diagnosis-content extracting portion that extracts, at least, the name of the illness and the name of the tissue site from the diagnosis request information acquired by the diagnosis-request-information acquisition portion; and a reference-information searching portion that searches the reference information stored in the reference-information storing server using the name of the illness and the name of the tissue site extracted by the diagnosis-content extracting portion.

### BRIEF DESCRIPTION OF THE SEVERAL VIEWS OF THE DRAWINGS

FIG. 1 is a diagram of the overall configuration of a pathological-diagnosis support system according to an embodiment of the present invention.

FIG. 2 is a functional block diagram showing, in an expanded manner, the functions of the pathological-diagnosis support device according to an embodiment of the present invention.

FIGS. 3A and 3B are diagrams showing examples of a color-phase detecting method employed by a color-phase detecting portion. FIG. 3A includes histograms showing the frequency distributions of the respective color components obtained from a virtual slide image of an HE-stained sample, and FIG. 3B includes histograms showing the frequency distributions of the respective color components obtained from a virtual slide image of an Her2-stained sample.

FIG. 4 is a coordinate space showing the relationship between the staining methods and the color ratios obtained from the histograms in FIGS. 3A and 3B.

FIG. 5 is a diagram showing an example of a screen displayed on a monitor of a pathologist's terminal.

FIG. 6 is a diagram showing a modification of the pathological-diagnosis support device in FIG. 2.

### DETAILED DESCRIPTION OF THE INVENTION

A pathological-diagnosis support device 1 and a pathological-diagnosis support system 100 according to an embodiment of the present invention will be described below with reference to the drawings.

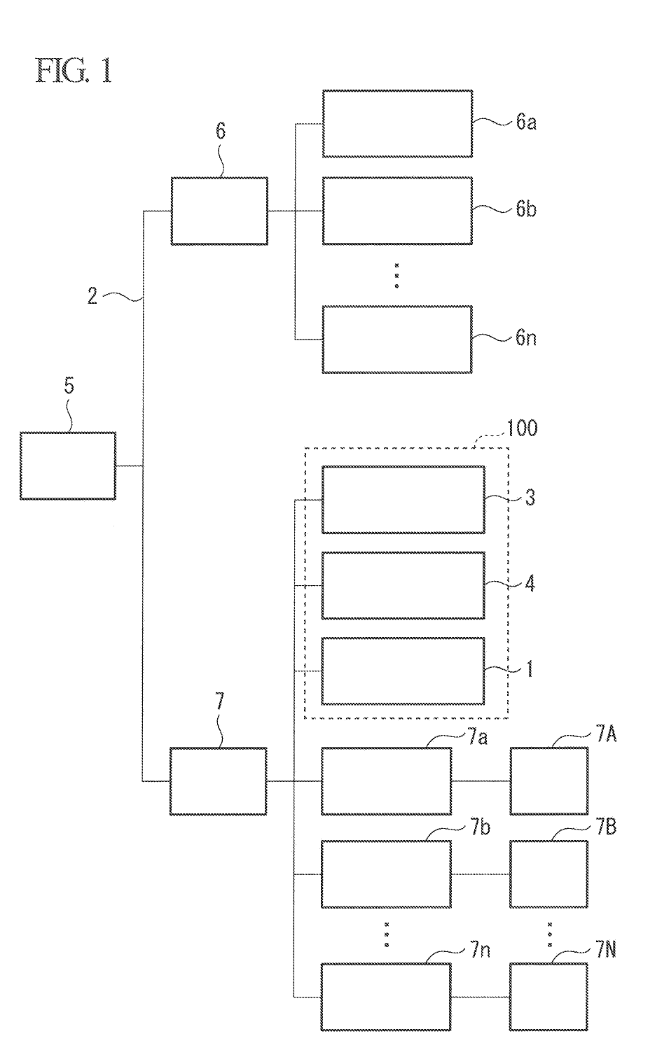

As shown in FIG. 1, the pathological-diagnosis support system 100 according to this embodiment is connected to an intra-hospital network 2 installed in a hospital. The pathological-diagnosis support system 100 includes the pathological-diagnosis support device 1 according to this embodiment, an image server 3 in which digital image data of pathological samples are stored, and an application server (reference information storing server) 4 in which an application (reference information) utilized by a pathologist when making a pathological diagnosis is stored.

The intra-hospital network 2 connects a hospital information management system (HIS) 5 for managing information in the entire hospital to local systems installed in the respective departments in the hospital. Examples of such local systems include, at least, a clinical information system (CIS) 6 and a laboratory information system (LIS) 7. Clinician's terminals 6a, 6b, 6n used by clinicians treating outpatients and house clinicians belong to CIS 6. Pathologist's terminals 7a, 7b, . . . , 7n installed in a laboratory and used by pathologists belong to LIS7.

The HIS 5, the CIS 6, and the LIS 7 have an HIS server, a CIS server, and an LIS server, respectively. Monitors 7A, 7B, . . . , 7N, serving as display devices, are connected to the pathologist's terminals 7a, 7b, . . . , 7n, respectively.

The CIS 6 sends information including diagnosis request information entered at the clinician's terminals 6a, 6b, 6n to the HIS 5. The diagnosis request information is generated as text data by, for example, a clinician entering necessary information in a predetermined format. The necessary information includes the clinician's opinion, such as the name of the illness diagnosed by the clinician, the tissue site from where the specimen was collected, and the method of collecting the specimen, in addition to the basic information of the patient, such as the name, date of birth, sex, and a patient ID assigned by the hospital to each patient.

In the case where the information received from the CIS 6 is diagnosis request information, the HIS 5 transfers the diagnosis request information to the LIS 7.

The LIS 7, upon receipt of the diagnosis request information from the HIS 5, issues a specimen ID for identifying the specimen of the patient corresponding to the diagnosis request information. Then, the LIS 7 sends the diagnosis request information, together with the information of the specimen ID, to the pathological-diagnosis support device 1.

The image server 3 stores a digital image of a pathological sample of the specimen generated in the laboratory (not shown) in association with the specimen ID. The pathological sample is formed by attaching a specimen collected from a patient and sent to the laboratory by a clinician to a slide glass and staining the specimen on the slide glass using a predetermined staining method. By reading an image of the thus-formed pathological sample, a virtual slide (VS) image, which is a digital image of the pathological sample, is generated.

At this time, for example, by attaching a bar code that stores the specimen ID to the slide glass together with the specimen, and by scanning them at once, the image data of the pathological sample and the specimen ID are stored in the image server 3 so as to be associated with each other. When new VS image data is stored, the image server 3 sends information indicating that VS image data is generated, together with the corresponding specimen ID information, to the pathological-diagnosis support device 1.

The application server 4 stores a pathological diagnosis manual, in which processes, important points, etc., of pathological diagnosis are described, and reference images, such as images of cases diagnosed previously and typical images of the respective cases. The items of the pathological diagnosis manual are broadly classified according to, for example, the staining method, and the items of each staining method are further classified in detail according to the illness, the tissue site, and the collecting method. In the pathological diagnosis manual, each item is stored so as to be associated with the staining method, the illness, the tissue site, and the collecting method described under the item. The reference images are stored so as to be associated with the illnesses, the tissue sites, the collecting methods, and the staining methods that are indicated by the images.

The pathological-diagnosis support device 1 is a computer having a central processing unit (CPU). The pathological-diagnosis support device 1 includes a diagnosis-request-information acquisition portion 8 that acquires diagnosis request information from the LIS 7, a diagnosis-content extracting portion 9 that extracts the content of the diagnosis request from the diagnosis request information, an application searching portion (reference-information searching portion) 10 that selects an application item stored in the application server 4 on the basis of the content of the diagnosis request extracted by the diagnosis-content extracting portion 9, an image acquisition portion 11 that acquires VS image data from the image server 3, a color-phase-information detection portion 12 that detects the color phase information of the VS image, staining-method determination portion 13 that determines the staining method indicated by the VS image, and an information output portion 14 that allows the VS image and the application to be outputted from the servers 3 and 4 to the pathologist's terminals 7a, 7b, . . . , 7n.

The diagnosis-request-information acquisition portion 8 receives the diagnosis request information as text data.

The diagnosis-content extracting portion 9 preliminarily stores, as keywords, the names of illnesses, the names of tissue sites, and the names of methods of collecting specimen that may be the subject of the pathological diagnosis. The diagnosis-content extracting portion 9 compares the keyword with the diagnosis request information acquired by the diagnosis-request-information acquisition portion 8. Thus, the diagnosis-content extracting portion 9 extracts character strings that match the keyword, i.e., the name of the illness and the name of the tissue site about which a clinician requested diagnosis, from the diagnosis request information.

In this case, it is preferable that the terms entered in the diagnosis request information by the clinician and the terms used as the keywords be the same so that the content of the diagnosis request is correctly extracted. For example, standardized terms based on dictionaries, such as SNOMED, are used for the names of illnesses and the names of tissue sites.

The image acquisition portion 11, once it has received information from the image server 3 that new VS image data is stored, acquires the VS image data from the image server 3.

The color-phase-information detection portion 12 detects color phase information from the VS image data acquired by the image acquisition portion 11. More specifically, for example, the color-phase-information detection portion 12 decomposes the color of each pixel in the VS image data into three color components, namely, red (R), green (G), and blue (B), and generates frequency distributions with classes defined by the values of the decomposed color components.

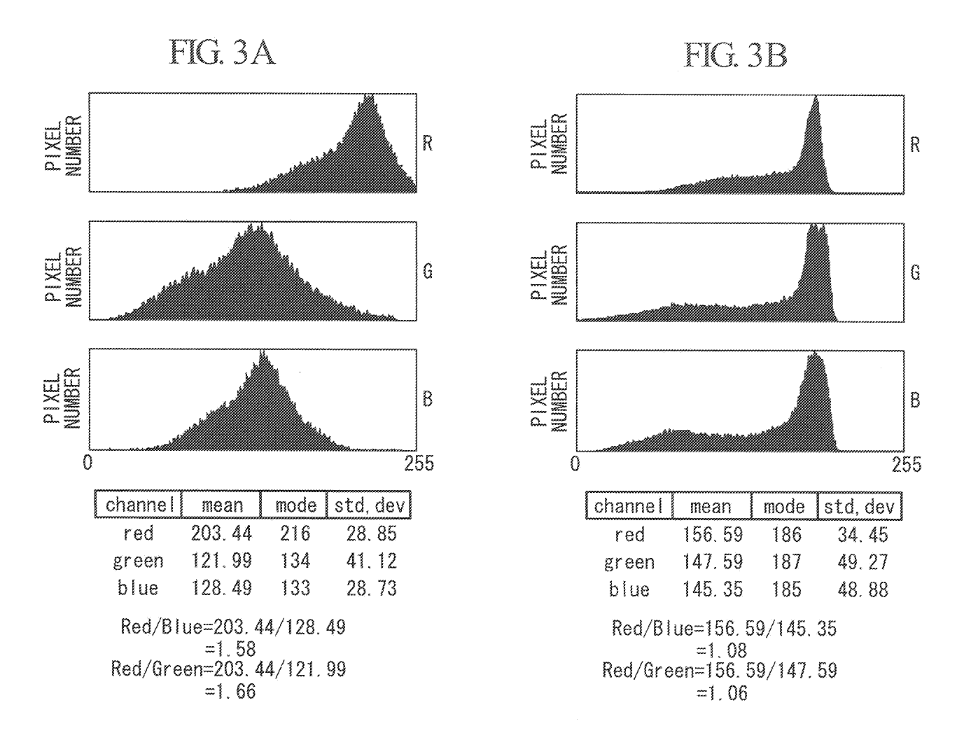

FIGS. 3A and 3B show examples of the histograms showing the thus-generated frequency distributions of the respective color components. FIG. 3A includes RGB histograms obtained from a pathological sample stained with an HE (hematoxylin and eosin) stain, and FIG. 3B includes RGB histograms obtained from a pathological sample stained with an Her2 stain, which is an immunostain. In the case of the HE stain, the nucleus of a cell is blue-violet, and a relatively large area except for the nucleus of the cell is red to pink. Therefore, the R values (mode) are in a high area compared with G and B. In the case of the Her2 stain, because the sample is brown-red, variations in RGB values (mean) are small.

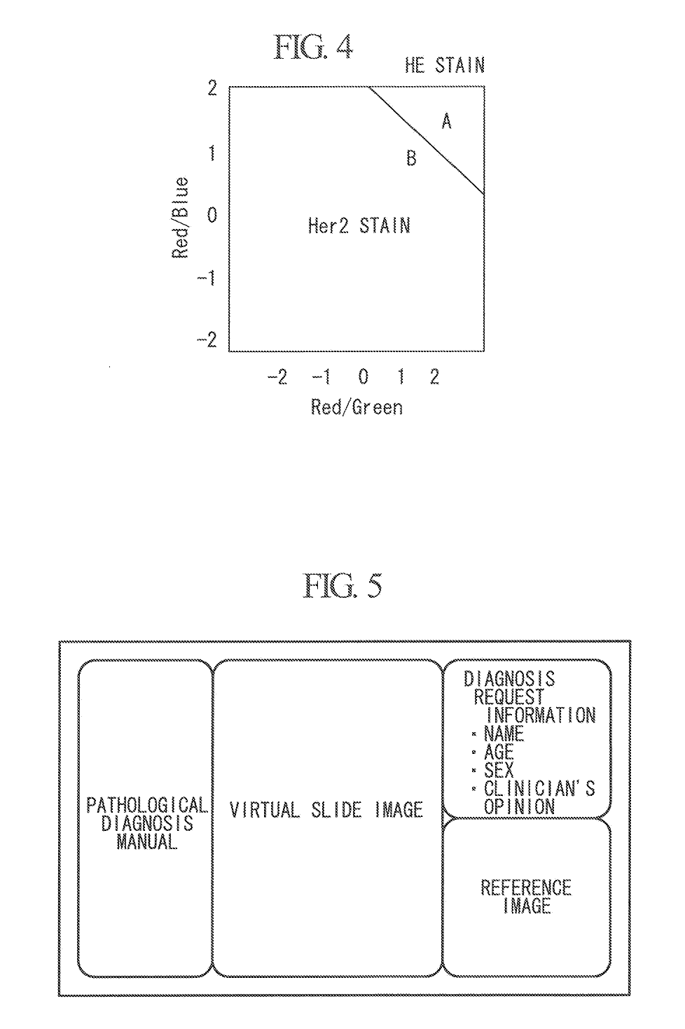

The staining-method determination portion 13 calculates, for example, Red/Blue, which is the ratio of the averages of R and B, and calculates Red/Green, which is the ratio of the averages of R and G. Then, as shown in FIG. 4, when the calculated value is included in an area A where the value of R is relatively large, the staining-method determination portion 13 determines that it is an HE stain. On the other hand, when the calculate value is included in an area B other than the area A, the staining-method determination portion 13 determines that it is an Her2 stain.

The application searching portion 10 searches items in the pathological diagnosis manual and reference images using the name of the illness and the name of the tissue site extracted by the diagnosis-content extracting portion 9 and the name of the staining method determined by the staining-method determination portion 13.

The operation of the thus-configured pathological-diagnosis support device 1 and pathological-diagnosis support system 100 according to this embodiment will be described below.

A clinician, once he or she has determined that a pathological diagnosis of a patient is necessary, sends a specimen collected from the patient to a laboratory. Along with this, the clinician enters the content of the diagnosis request at the clinician's terminal 6a, 6b, . . . , or 6n, used by the clinician, and sends the diagnosis request information to the CIS 6. By this, the diagnosis request information is sent to the diagnosis-request-information acquisition portion 8 of the pathological-diagnosis support device 1 via the HIS 5 and the LIS 7. After the diagnosis request information is acquired by the diagnosis-request-information acquisition portion 8, the diagnosis-content extracting portion 9 extracts the name of the illness and the name of the tissue site from the diagnosis request information. Then, the extracted name of the illness and the name of the tissue site are sent to the application searching portion 10.

Meanwhile, when VS image data of the specimen is generated and is stored in the image server 3 in the laboratory, the VS image data is acquired by the image acquisition portion 11. Then, the VS image data is transferred to the pathologist's terminals 7a, 7b, . . . , 7n through the information output portion 14, after the staining method is determined by the staining-method determination portion 13 via the color-phase detecting portion 12.

The information of the staining method determined by the staining-method determination portion 13 is sent to the application searching portion 10. Then, the application searching portion 10 searches items in the pathological diagnosis manual and reference images using the name of the illness and the name of the tissue site extracted by the diagnosis-content extracting portion 9 and the name of the staining method determined by the staining-method determination portion 13.

Then, the data of the reference image with the same conditions as the VS image and the data of the item in the manual suitable for the diagnosis of the VS image are sent from the application server 4 to the pathologist's terminals 7a, 7b, . . . , 7n. Then, as shown in FIG. 5, the VS image, the reference image, and the pathological diagnosis manual are displayed in a side-by-side manner on the monitors 7A, 7B, . . . , 7N connected to the pathologist's terminals 7a, 7b, . . . , 7n. The pathologist diagnoses the VS image displayed on the monitors 7A, 7B, . . . , 7N by referring to the reference image and the manual that are displayed side-by-side with the VS image.

Thus, in this embodiment, information necessary for diagnosis is shown to the pathologist side-by-side with the VS image for which a diagnosis was requested on the monitors 7A, 7B, . . . , 7N. This provides advantages in that it is possible to save pathologists themselves from having to confirm the content of the diagnosis request from clinicians or from having to search for the most appropriate reference image and item of the pathological diagnosis manual, thereby reducing the burden on the pathologists and increasing the efficiency of pathological diagnosis.

Although the name of the staining method instructed by the clinician is determined on the basis of the color phase of the VS image data in the above-described embodiment, it may be determined on the basis of the text data of the diagnosis request information instead.

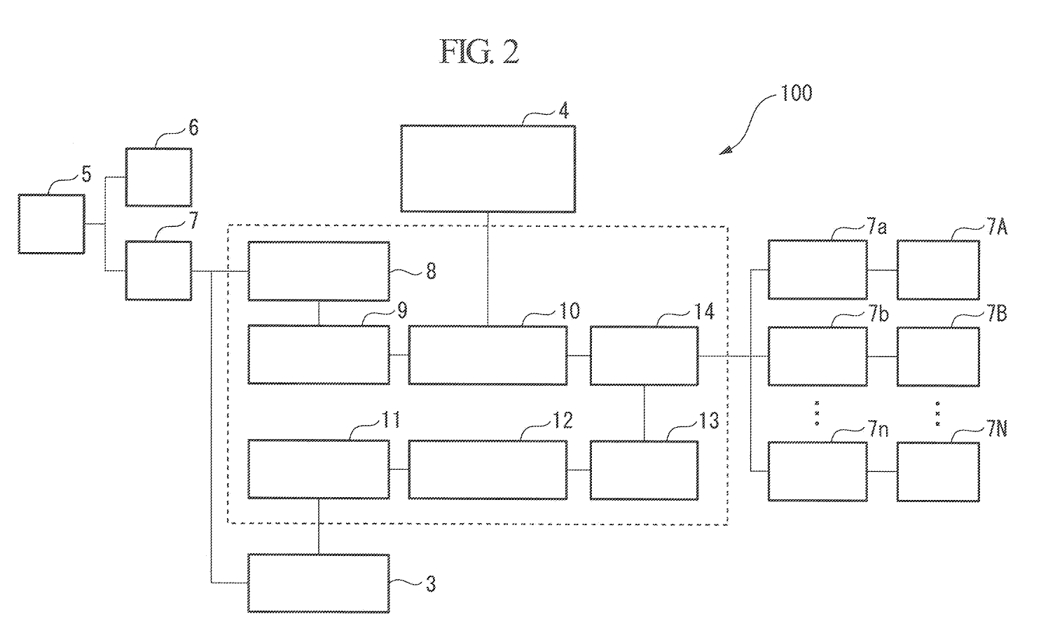

Like the names of illnesses and the names of tissue sites, various names of staining methods instructed by clinicians are preliminarily stored as keywords in the diagnosis-content extracting portion 9, and similarly to the other details of the diagnosis, the staining method is extracted from the character string contained in the diagnosis request information. For the names of the staining methods, specific abbreviations, such as HE for hematoxylin and eosin stain and IHC for immunostain, are used. With this configuration, i.e., by omitting the color-phase detecting portion 12 and the staining-method determination portion 13 in FIG. 2 and by connecting the image acquisition portion 11 to the information output portion 14, the configuration can be simplified and the staining method can be properly determined.

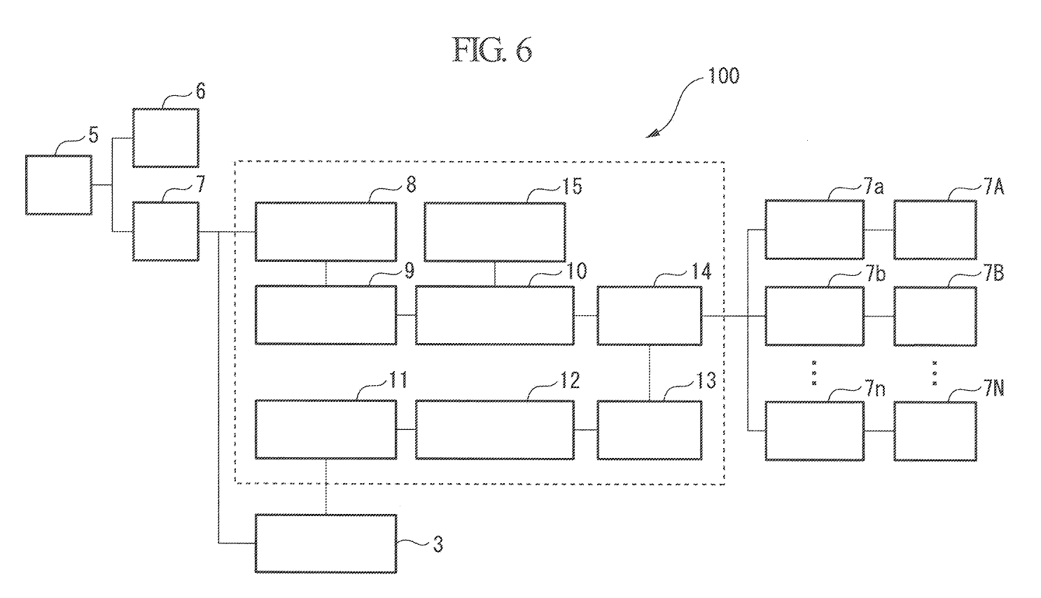

Although reference information, such as pathological diagnosis manuals and reference images, are stored in the application server 4 that is provided separately from the pathological-diagnosis support device 1 in the above-described embodiment, the reference information may be stored in a storing portion (reference-information storing portion) 15 of the pathological-diagnosis support device 1 instead, as shown in FIG. 6.

This also provides the same advantages as the above-described embodiment.

What is claimed is:

1. A pathological-diagnosis support device comprising:
a reference-information storing portion in which reference information referred to by a pathologist when making a pathological diagnosis is stored in association with, at least, the names of illnesses and the names of tissue sites indicated by the reference information;
a diagnosis-request-information acquisition portion that acquires diagnosis request information including, at least, the name of the illness of a patient and the name of the tissue site;
a diagnosis-content extracting portion that extracts, at least, the name of the illness and the name of the tissue site from the diagnosis request information acquired by the diagnosis-request-information acquisition portion; and
a reference-information searching portion that searches the reference information stored in the reference-information storing portion using the name of the illness and the name of the tissue site extracted by the diagnosis-content extracting portion.

2. The pathological-diagnosis support device according to claim 1, further comprising:
an image acquisition portion that acquires digital image data of a specimen of the patient whose diagnosis request information was acquired by the diagnosis-request-information acquisition portion;
a color-phase-information detection portion that detects color phase information contained in the digital image data acquired by the image acquisition portion; and
a staining-method determination portion that determines the name of a method of staining the specimen on the basis of the color phase information detected by the color-phase-information detection portion, wherein
the reference-information storing portion stores the reference information in association with the name of the staining method indicated by the reference information, and
the reference-information searching portion searches the reference information stored in the reference-information storing portion using the name of the staining method determined by the staining-method determination portion.

3. The pathological-diagnosis support device according to claim 1, further comprising:
an image acquisition portion that acquires digital image data of a specimen of the patient whose diagnosis request information was acquired by the diagnosis-request-information acquisition portion; and
a display device that displays the digital image data acquired by the image acquisition portion and the reference information searched by the reference-information searching portion in a side-by-side manner.

4. The pathological-diagnosis support device according to claim 1, wherein
the diagnosis-request-information acquisition portion acquires the diagnosis request information including the name of a method of collecting the patient's specimen, and
the reference-information searching portion searches the reference information stored in the reference-information storing portion using the name of the collecting method.

5. The pathological-diagnosis support device according to claim 1, wherein
the diagnosis-request-information acquisition portion acquires the diagnosis request information including a method of staining the patient's specimen, and
the reference-information searching portion searches the reference information stored in the reference-information storing portion using the name of the staining method.

6. The pathological-diagnosis support device according to claim 1, wherein the reference information is digital images of cases diagnosed previously.

7. The pathological-diagnosis support device according to claim 1, wherein the reference information is a manual in which methods of diagnosis classified according to, at least, the illness and the tissue site are described.

8. A pathological-diagnosis support system comprising:
a reference-information storing server in which reference information referred to by a pathologist when making a pathological diagnosis is stored in association with, at least, the names of illnesses and the names of tissue sites indicated by the reference information; and
a pathological-diagnosis support device that is connected to the reference-information storing server through a network, wherein the pathological-diagnosis support device includes:
a diagnosis-request-information acquisition portion that acquires diagnosis request information including, at least, the name of the illness of a patient and the name of the tissue site;
a diagnosis-content extracting portion that extracts, at least, the name of the illness and the name of the tissue site from the diagnosis request information acquired by the diagnosis-request-information acquisition portion; and
a reference-information searching portion that searches the reference information stored in the reference-information storing server using the name of the illness and the name of the tissue site extracted by the diagnosis-content extracting portion.
